(19) United States
(12) Patent Application Publication
(10) Pub. No.: US 2016/0217382 A1
(43) Pub. Date: Jul. 28, 2016

(54) METHOD FOR IDENTIFYING AN APPLICATION COMPONENT

(71) Applicant: Capriza Inc., Palo Alto, CA (US)

(72) Inventors: Dror Schwartz, Holon (IL); Ido Ish-Hurwitz, Kfar Saba (IL); Sagi Monza, Rishon Le Tzion (IL); Roie Uziel, Rehovot (IL); Assaf Dagan, Modiin (IL)

(73) Assignee: Capriza Inc., Palo Alto, CA (US)

(21) Appl. No.: 14/604,786

(22) Filed: Jan. 26, 2015

(51) Int. Cl. G06N 5/04; G06F 17/22

(52) U.S. Cl. CPC G06N 5/048; G06F 17/2247

(57) ABSTRACT

An assisted method to identify an application component. User interaction with a component of an interactive software component is monitored, locator associated with each aspect of the component is identified, and a reconstructed version of the interactive software application is provided based on pieces of information derived from the response of the user on presented questions. The method is then determining the likelihood of the identification of a candidate component.

### FIELD OF THE INVENTION

The present invention relates to graphically interactive programs, frequently referred to as software applications, and the interpretation of user interactions with a computerized system. The invention is to do with an assisted method to identify an application component, e.g. a page or a control on an application page.

### BACKGROUND OF THE INVENTION

The programming environment in which the present invention is implemented, relates to interactive programs (frequently referred to as software applications) in which the user is presented with a sequence of interface pages, each one at a time. Each one of the pages usually demonstrates several appended graphic entities with which the user can interact, either by receiving information or feeding information or giving direct instructions. A typical program language of the type employed for such tasks are markup languages such as HTML or XHTML.

HTML pages can be described each as a tree of components arranged in a hierarchical order. Each page typically includes a number of components. (e.g., an image, a textbox, a link, etc.). Controls are specific type of components in a page the user interacts with. Aspects describe part of most components, which contribute to the functional definitions of each component. Exemplary aspect types are syntax (e.g. “id” which specifies unique id for a component), visual attribute (e.g. color, shape), semantic (e.g. table headers, label). A locator class is specific to one aspect of the application component. For each component, instances of the relevant classes are created. Instances of a locator class are called “locators”. Each locator contains data on the specific aspect of the associated component.

### SUMMARY OF THE INVENTION

The invention pertains to a method for identifying foreign application component. The framework of the inventive set-up, supports the implementation of a dual mechanism. On the one hand, a component by component analysis of an existing operational program is carried out, to establish one or more versions of a putative reconstructed program. This reconstruction can be assisted by a trainer. On the other hand, when a foreign application component is intercepted, to be further assessed, implementing an identification process. This assessment is carried out by applying a set of locators defined for that component, calculating the component score as a mathematical combination of individual appraisals generated for each locator and determining the success of the identification of the component based on the combined appraisal score, respective of a reconstructed program.

### BRIEF DESCRIPTION OF THE DRAWINGS

The present invention will be understood and appreciated more fully from the following detailed description taken in conjunction with the appended drawings in which:

FIG. 1 is a schematic drawing showing the structure of a page in an interactive operational program side by side with the reconstructed page using the mechanism in accordance with the present invention.

FIG. 2 is a schematic description of the sources of data for the RM (reconstruction mechanism) showing the different input streams feeding the RM in the running of an instance of a component based interactive program.

FIG. 3 is a schematic description of a page on which three textbox components are distributed.

FIG. 4A and FIG. 4B show a flow diagram showing applying the RM to a graphic component from a page of an EIP and identifying it, taking part in the mechanism of the invention.

### DESCRIPTION OF EMBODIMENTS OF THE INVENTION

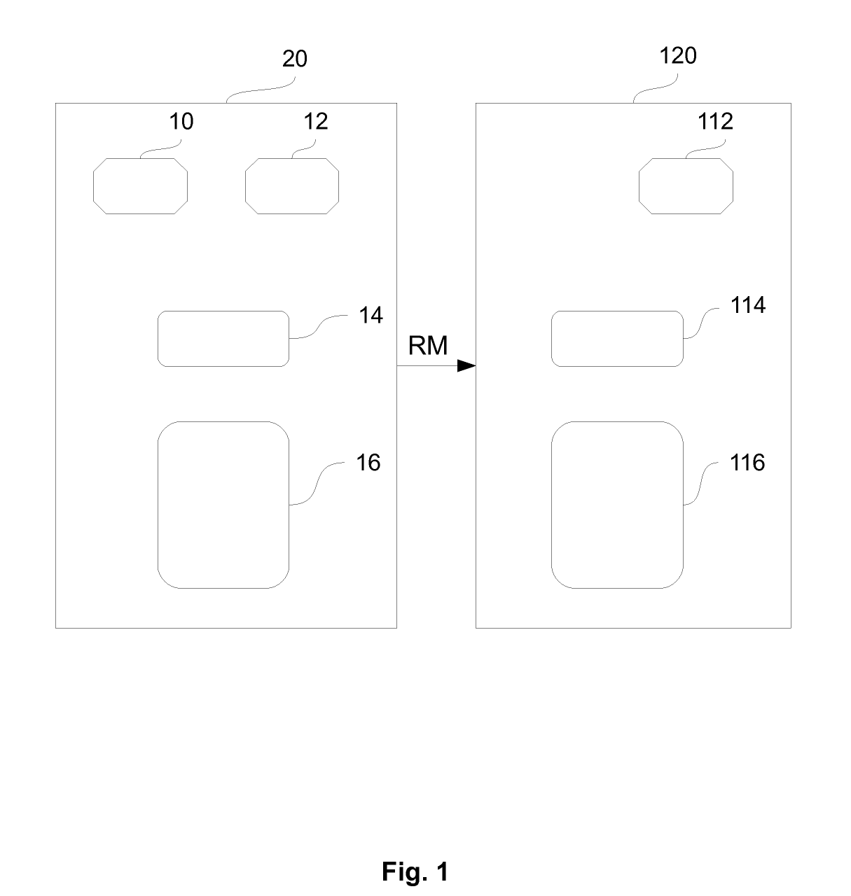

The present invention is to do with a mechanism for reconstructing a putative interactive operational program. Subsequently to that, intercepted foreign components are identified with respect of the reconstructed program. The entire interactive program is typically characterized by a flow of pages, each one exhibiting one or more graphical components, this flow being driven by the interaction of a user with the entire interactive program (EIP). In the running of such an interactive program, frequently referred to as software applications, the user interacts with graphic components on given application pages. As can be seen in FIG. 1, original graphic page 20 of an EIP includes several graphic components: graphic component 10, graphic component 12, graphic component 14 and graphic component 16. Page 120 represents the reconstructed page 20, it includes, the graphic components: 112—representing given graphic component 12; 114—representing given graphic component 14; and 116—representing given graphic component 16.

In a training and knowledge phase, assumptions regarding the aspects of the components are generated and made available to the RM as a preconfigured database. These assumptions are translated to human intelligible questions and proposed preferred answers and presented to the user during the execution of the RM, as detailed below.

### The Reconstruction Mechanism

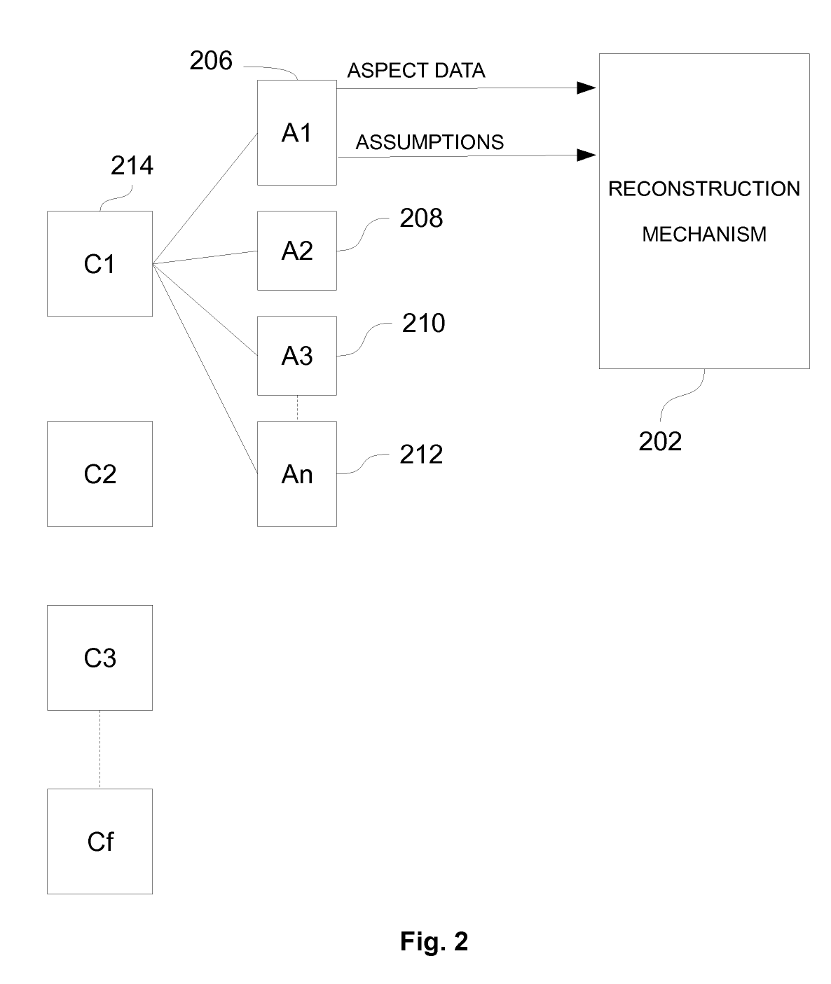

The reconstruction mechanism (RM), is in one phase capable of collecting information about the components of the application, component by component, and further analyze these components. This phase typically utilizes user assistance. As illustrated in FIG. 2, RM 202 collects identifiers which characterize the components: for each aspect associated with the component, aspect data (e.g. the aspect value, auxiliary data such as the tag name of the component the aspect is associated with) and assumptions (e.g. 206—aspect A1; 208—aspect A2; 210—aspect A3, etc.), related to a component (e.g. 214—C1). The aspect data and the assumptions constitute the two data sets inputted to the RM. The nature of these two data sets will be discussed below.

In the background of the RM, the RM constructs a synthetic version of the EIP or a few versions thereof, hereinafter referred to as a reconstructed interactive program (RIP), supervised by a user, making the reconstruction in this embodiment a supervised reconstruction.

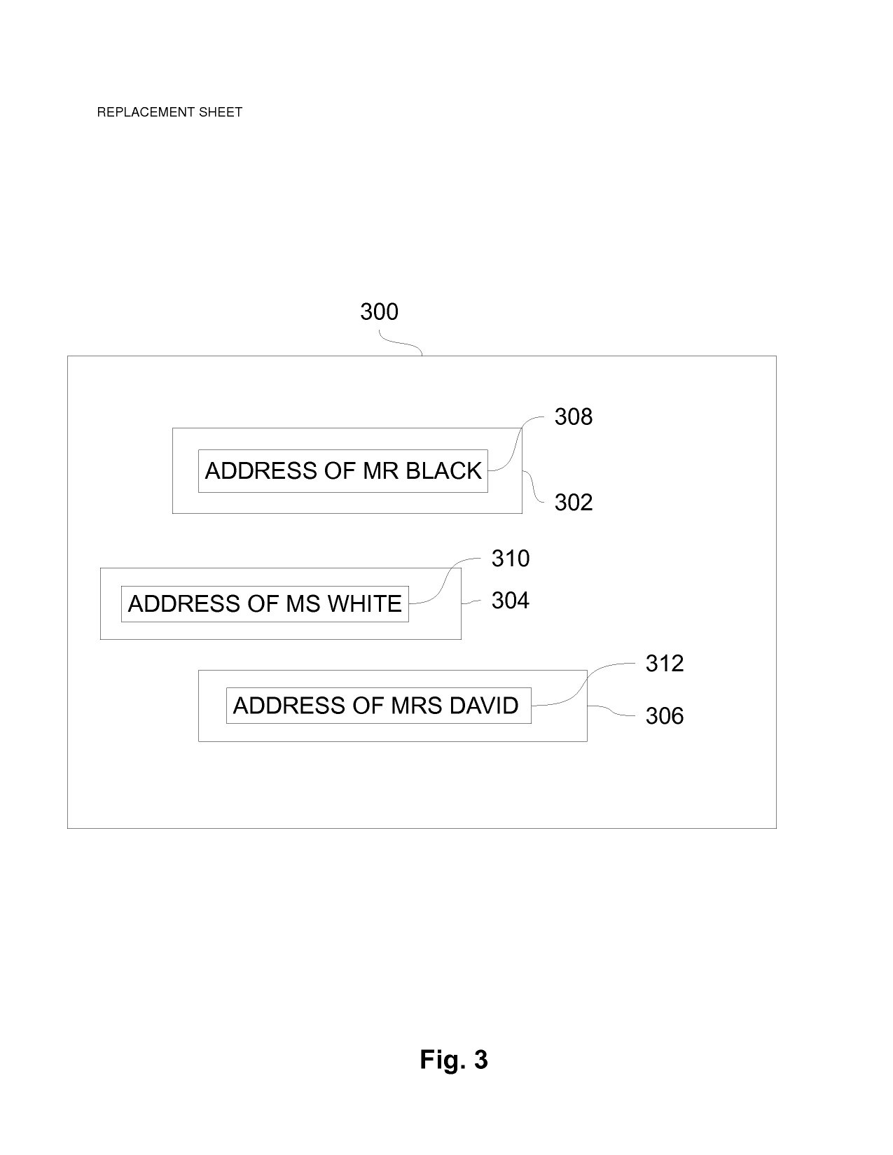

In order to explain some aspects of the user assistance stage which takes place in the RM, reference is made to FIG. 3, which illustrates an exemplary implementation in which an application page 300 composed of three similar textbox components 302, 304 and 306 respectively, including a label with a static part “ADDRESS OF” and a non-static part “MR BLACK”/“MS WHITE”/MRS DAVID” learns about the label 308 related to textbox component (label is defined as one aspect of a textbox component).

The RM creates for that textbox a locator of class “label-based-locator”. The automated identification algorithm assumes that the label is static—stays the same throughout the running of the reconstruction mechanism for that component. The assisted mode enables the user to specify if indeed the label is static or only part of it is, and which one of the three textbox components it is related to.

The RM generates a question, as explained above: “is the label always set as address of Mr. Black”? The user provides a response as follows: “address of” is the static part of the label. The RM then updates the assumption of the locator with pieces of information (POI) derived from the response provided by the user. Then in this case, as there are three text box components (the RM analyzes the entire page), a follow up question: “is that the first of the three textbox components with that label?” is presented as several such components are identified by the RM on the application page.

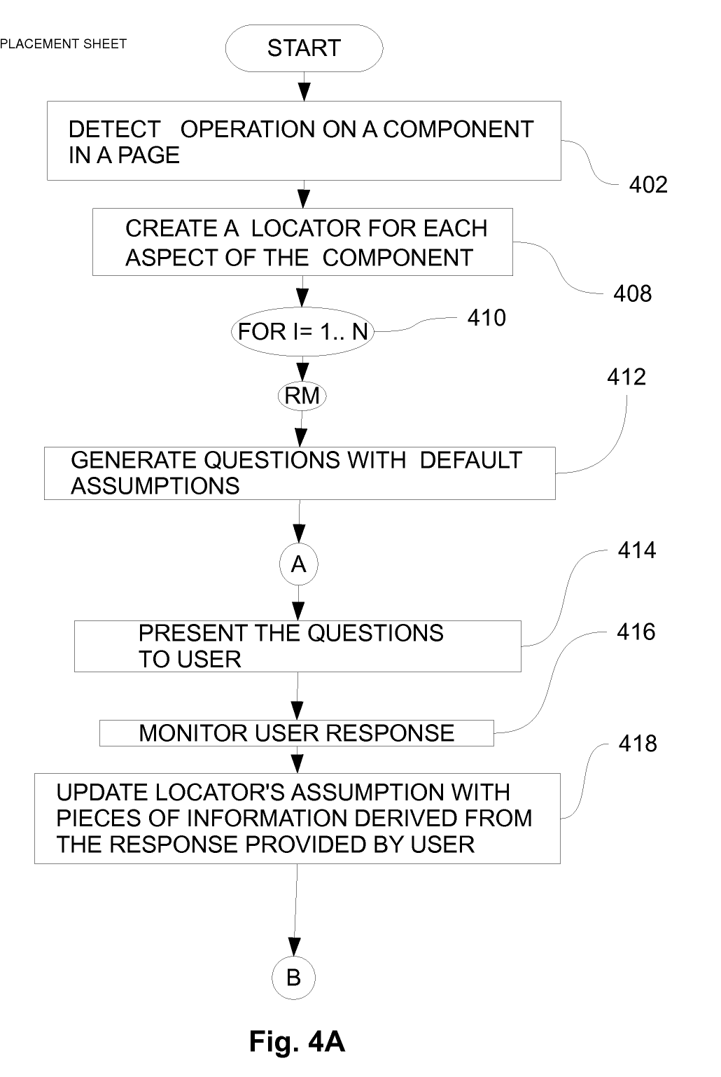

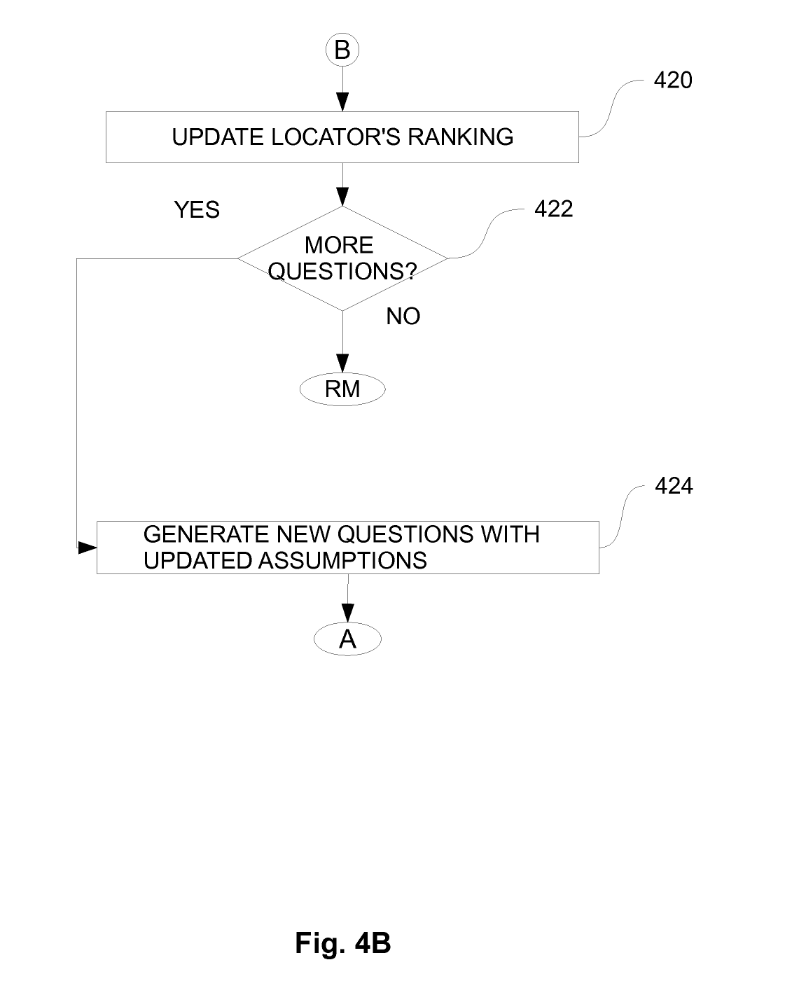

As briefly referred to above, the RM collects information about an EIP's component, implementing the assisted method which includes a sequence of steps as further explained in FIGS. 4A-B. In operation 402, the user interacts with a component in a page when executing the EIP. In operation 408, the RM is used to indicate a component of the reconstructed page of the RIP. An identifying aspect of this component is associated with a locator and processed by the RM. In operation 412, the RM generates questions, answers derived from default assumptions and presents them to the user as shown in operation 414. The questions and proposed answers represent the translation of the assumptions to human intelligible questions and answers. The user is asked to respond and from his/her response POI are derived, which the RM monitors as shown in operation 416. Such POI either validate or invalidate the assumptions, adding information to those assumptions, as per operation 418 and the RM updates the ranking of the locator to mark the confidence level related to this locator as shown in operation 420. In FIG. 4B, if more questions are required as verified in step 422, such questions can be derived from updated assumptions as shown in operation 424.

In addition, each execution of the RIP, the ranking for this locator may be re-evaluated and/or adjusted to reflect a new assessment of the locator's usefulness to component identification. The algorithm does not change the identification rule but rather its rank, hence its weight in the total identification function for that component. The ranking method is similar to the importance score method disclosed in patent U.S. Pat. No. 8,572,095 B2, columns 5-6 and claims 1-4. In the case of the example illustrated at FIG. 3, the number of times the label was the same as expected—“always address of Mr. Black” (e.g. 10 times out of 10 runs)—will increase the confidence level of the label locator for that component. Otherwise if in 6 out of 10 runs, the label was not the same, the locator assumption—“label is static” is considered to be wrong and the locator's assumption may be changed to another assumption, e.g. “label is dynamic”.

The number of runs is determined by the user executing the RM.

The results (updated assumptions and ranking) are saved for each component in the RIP and are part of the total identification function related to it.

### Determining Intercept Page and Intercepted Component

Intercepted application component is identified as a component in the RIP by applying the set of locators defined for that component, calculating the component score as a combination of the individual appraisals generated for each locator. The likelihood of the identification of a component is a function of the combined appraisal scores, thus the component is identified if the combined appraisal score for the given component exceeds a predetermined threshold value.

In a special case where the intercepted component is not identified, e.g. the combined appraisal score is under the predetermined threshold value, the intercepted component is refuted.

An ambiguity may exist when two reconstructed pages are composed of the same identified components. In such a case, the ambiguity is solved e.g. by using the method disclosed in the U.S. patent application Ser. No. 14/134,919, which is incorporated herein by reference in its entirety.

1. A method for providing a user with at least one reconstructed version of an interactive software application, said method comprising:
a. monitoring user interaction with a component in a page of said software application;
b. identifying a locator associated with each aspect of said component;
c. keeping two sets of identifiers associated with said locator in the reconstructed program, one set being a set of aspect data, and the other being a set of assumptions;
d. generating at least one question, as well as suggested answer and alternative answers derived from said assumptions;
e. presenting said at least one question to said user;
f. obtaining a response to said at least one question from said user , and
g. updating said set of assumptions, based on pieces of information (POI) derived from the response of said user.

2. A method according to claim 1, further comprising:
h. based on said updated assumptions, performing the following sequence of steps at least once:
(1) generating at least one new question, as well as suggested answer and alternative answers derived from the updated assumptions,
(2) presenting said at least one question to said user;
(3) obtaining a response to said at least one new question from said user and updating said locator assumptions, based on POI derived from the response of said user, and
(4) updating the ranking of the locator.

3. A reconstruction mechanism as in claim 1 wherein said components are created using a markup language.

4. A reconstruction mechanism as in claim 2 wherein said components are created using a markup language.

5. A method for determining the likelihood of identification of a candidate component of an interactive software application from the reconstructed version implemented by the method in claim 1, said method comprising:
intercepting a candidate component;
applying the set of locators to the said component;
calculating the component score as a combination of the individual appraisals generated for each locator and,
implementing a decision rule to decide about the success of the identification of said component.

6. A method for determining the likelihood of identification of a candidate component of an interactive software application from the reconstructed version implemented by the method in claim 2, said method comprising:
intercepting a candidate component;
applying the set of locators to the said component;
calculating the component score as a combination of the individual appraisals generated for each locator and,
implementing a decision rule to decide about the success of the identification of said component.

7. A method for identifying an application component, said method comprising:
a. providing a user with at least one reconstructed version of an interactive software application according to the following steps:
(a.1) performing user interaction with a component in a page of said interactive software application;
(a.2) identifying a locator associated with each aspect of said component;
(a.3) keeping two sets of identifiers associated with said locator in the reconstructed program , one set being a set of aspect data, and the other being a set of assumptions;
b. performing user interaction with the said reconstructed version;
c. performing the following sequence of steps at least once:
(c.1) determining the likelihood of identification of a candidate component of the said reconstructed version according to the following steps:
intercepting a candidate component;
applying the set of locators to the said component;
calculating the component score as a combination of the individual appraisals generated for each locator;
implementing a decision rule to decide about the success of the identification of said component;
(c.2) if said component is successfully identified then validating assumptions of said locator based on said likelihood, and updating the ranking of the said locator.
